(19) United States
(12) Patent Application Publication
(10) Pub. No.: US 2004/0145525 A1
(43) Pub. Date: Jul. 29, 2004

(54) Plate antenna

(76) Inventors: Ayoub Annabi, Dole (FR); Frederic Diximus, Dole (FR); Roland Vincent, Dole (FR); Daniel Leclerc, Crissey (FR)

Correspondence Address: BLANK ROME LLP, 600 NEW HAMPSHIRE AVENUE, N.W., WASHINGTON, DC, 20037, US

(21) Appl. No.: 10/479,169

(22) PCT Filed: May 30, 2002
(86) PCT No.: PCT/FR02/01818

(30) Foreign Application Priority Data
Jun. 1, 2001 (FR) 01/07227

(51) Int. Cl. H01Q 1/38

(52) U.S. Cl. 343/700 MS

(57) ABSTRACT

The invention relates to a patch type antenna comprising:

a ground plane (10); and

a radiating element disposed facing the groundplane-forming means.

The antenna further comprises:

a passive component (16) disposed entirely facing said radiating element (12) without direct electrical contact therewith in order to provide electromagnetic coupling between said passive component and said radiating element, said passive component having no mechanical connection between itself and the radiating element so that an empty space exists between itself and the radiating element, said passive component being isolated from the ground plane and being electrically connectable to the antenna feed point. In addition, said antenna system does not have a short-circuit between said radiating element and the ground plane.

The present invention relates to a patch antenna, and particularly but not exclusively to a patch antenna suitable for portable radiotelephones.

With portable radiotelephones, the trend is to replace an external antenna by an internal antenna of the patch type. In simplified terms, a patch antenna comprises firstly a ground plane and secondly a radiating element which, in this particular case is a conductive plate which is electromagnetically connected to an antenna conductor generally referred to as a “feeder”.

European patent application 1 091 444 discloses a patch type antenna comprising a ground plane, a radiating plate parallel to said ground plane, and a portion of conductive plate electrically interconnecting the radiating plate and the ground plane. This portion of plate constitutes a short circuit. Electromagnetic coupling between the antenna conductor and the radiating plate is constituted by a metal plate disposed facing the radiating plate, said metal plate being connected to the central conductor of the antenna feeder. By electro-magnetic coupling, a connection is thus obtained between the antenna feeder and the radiating plate, both in transmission and in reception.

Nevertheless, that type of patch antenna presents a drawback when it is desired specifically to use it in a portable radiotelephone. Under such circumstances, the ground plane is generally made on a portion of the printed circuit of the radiotelephone while the radiating plate is fixed to the bottom of its case. In order to make the above-mentioned short circuit, it is therefore necessary to provide a conductive plate element and a short-circuiting electrical connector member between said plate and the ground plane so as to provide the short-circuit function. In addition, it is necessary for the electrical connection between the short-circuit plate and the ground plane to be uniform and to present high conductivity, which makes it necessary to use a relatively elaborate short-circuiting electrical connection system between the plate and the ground plane. The use of such a connector thus significantly increases the overall cost of the antenna whereas, as is well known, the trend is towards reducing the cost of manufacturing portable radiotelephones.

An object of the present invention is to provide an antenna of the patch type which makes it possible to avoid the above-mentioned drawbacks, and in particular to avoid using a connector for achieving the short circuit.

According to the invention, this object is achieved by an antenna system of the patch type comprising groundplane-forming means, a radiating element placed in register with the groundplane-forming means and disposed at a predetermined distance from the plane; and it further comprises:

a passive component entirely disposed facing said radiating element without direct electrical contact therewith so as to provide electromagnetic coupling between said passive component and said radiating element, said passive component having no mechanical connection between itself and the radiating element so as to leave an empty gap between itself and the radiating element, said passive component being isolated from the groundplane-forming means and being electrically connectable to the antenna feed point. Furthermore, the antenna system does not have any means forming a short circuit between said radiating element and said groundplane-forming means.

It will be understood that because the antenna system does not have a short circuit, the above-mentioned drawbacks are avoided. It should be added that by appropriately selecting the characteristics of the passive component and its position relative to the radiating element, it is possible to obtain appropriate impedance matching, e.g. at 50 ohms, without using special impedance-matching components. In a first embodiment, the passive component is constituted by a conductive plane electrically connected to the antenna feed point and connected to the groundplane-forming means by a short circuit.

In a second embodiment, the passive electrical is a conductive plane connected to the antenna feed point.

Another object of the invention is to provide an antenna of the above-mentioned type which also makes it possible to adapt the width of the passband corresponding to the frequency(ies) at which the antenna is to operate, and which furthermore makes it possible to reduce the length, i.e. the overall dimensions of the antenna for predetermined frequency ranges.

In order to achieve this object, the antenna system is characterized in that it further comprises matching means distinct from the passive component, these matching means being mounted between the radiating element, e.g. the radiating plate, and the groundplane-forming means.

These matching means which are added to the passive component serving to provide electromagnetic coupling between the antenna feeder and the radiating element make it possible for a particular shape of the radiating element, and in particular of the radiating plate, to adapt the width of the passband and to reduce the geometrical dimensions of the radiating element.

In a first variant of the improved embodiment of the invention, the matching means comprises a second conductive surface completely in register with a second zone of the radiating element and without electrical or mechanical contact with said radiating element, said second conductive surface being electrically connected to the groundplane-forming means.

In a second variant of the improved embodiment, the matching means comprise a variable capacitor element having one plate connected to the radiating element and having its other plate connected to the groundplane-forming means. By selecting an appropriate capacitance, it is possible to adjust or adapt the bandwidth of the antenna obtained in this way.

The impedance of the system providing electro-magnetic coupling between the second surface and the radiating element enables the bandwidth of the antenna to be modified for the working frequencies under consideration.

In a preferred embodiment, in addition to the second conductive surface, the matching means comprise a matching component which is electrically connected between the second conductive surface and the groundplane-forming means.

Because of the presence of this component, it is possible to adapt the bandwidth and to reduce the length of the plate of the radiating element more accurately and to a greater extent.

In particular, the matching component may advantageously be constituted by a capacitor or possibly by an inductor.

Other characteristics and advantages of the invention appear more clearly on reading the following description of various embodiments of the invention given as non-limiting examples.

The description refers to the accompanying figures, in which:

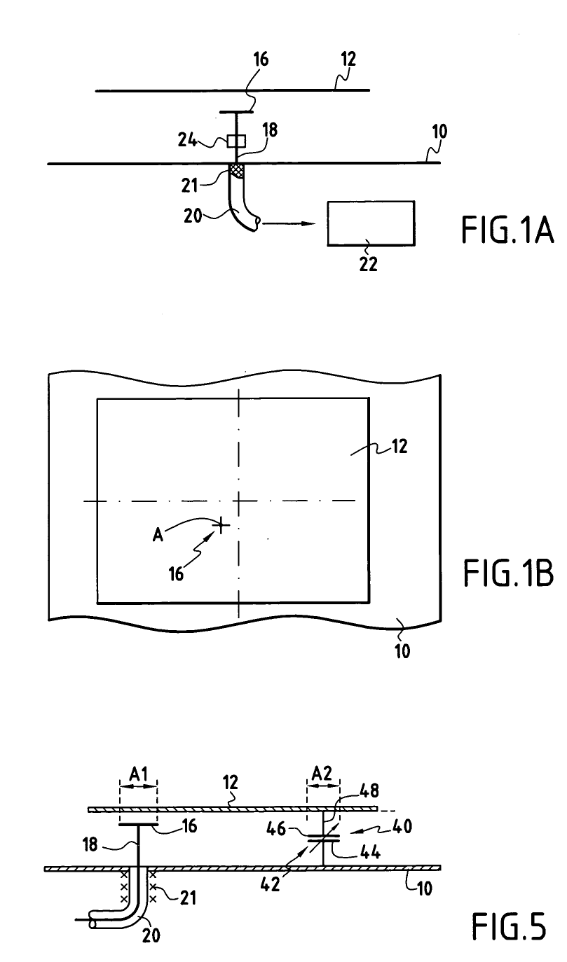

FIG. 1A is an elevation view of a simplified embodiment of the antenna of the invention;

FIG. 1B is a plan view of the antenna shown in FIG. 1A;

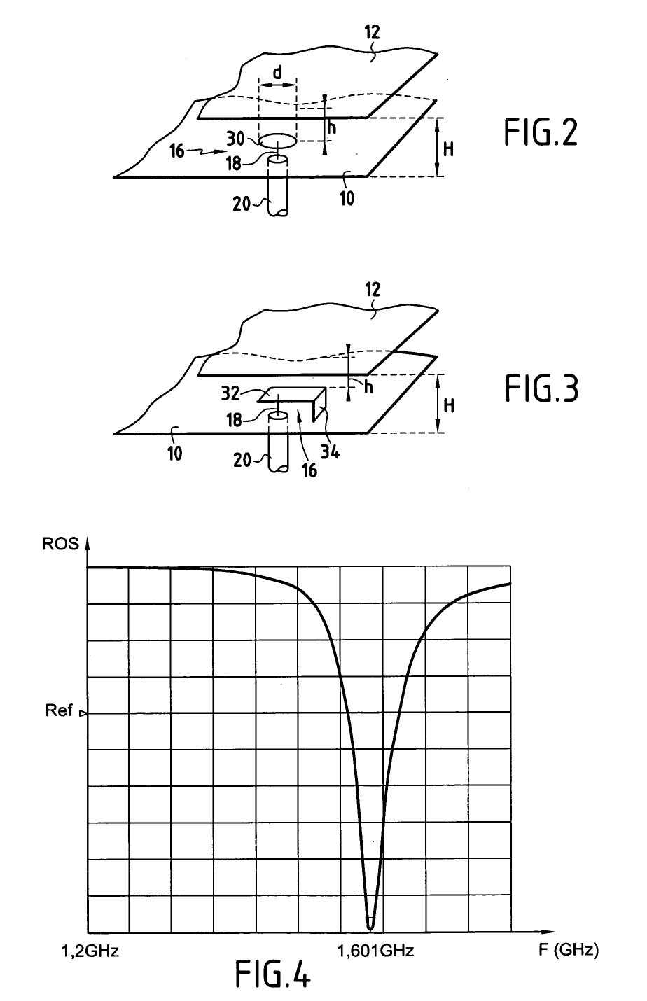

FIG. 2 is a fragmentary perspective view of a first embodiment of the antenna of FIG. 1A;

FIG. 3 is a second embodiment of the antenna shown in FIG. 1A;

FIG. 4 is a curve showing how the antenna of FIG. 2 operates;

FIG. 5 is an elevation view of a first variant of the improved embodiment of the antenna;

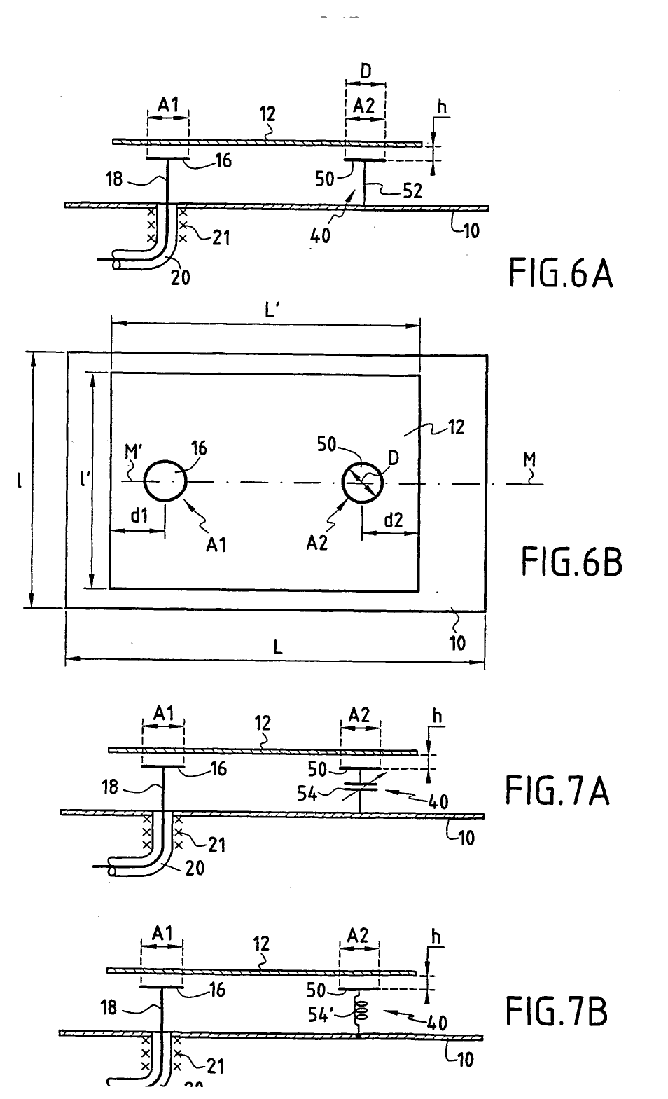

FIGS. 6A and 6B are respectively an elevation view and a plan view of an improved second embodiment of the antenna;

FIG. 7A shows a first variant of the embodiment of FIG. 6A;

FIG. 7B shows an alternative to the first variant of the embodiment of FIG. 6A;

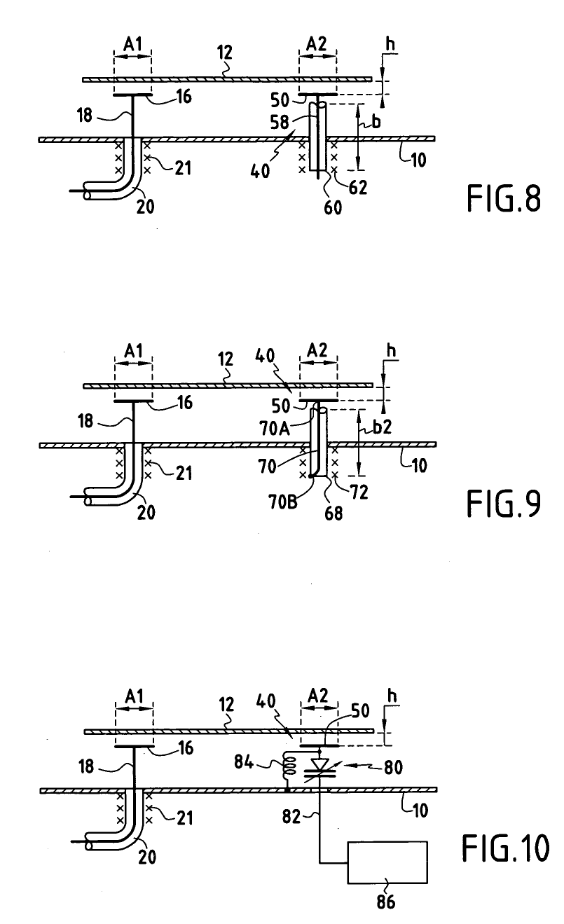

FIG. 8 shows a second variant of the embodiment of FIG. 6A;

FIG. 9 shows a third variant of the embodiment of FIG. 6A;

FIG. 10 shows a fourth variant of the embodiment of FIG. 6A; and

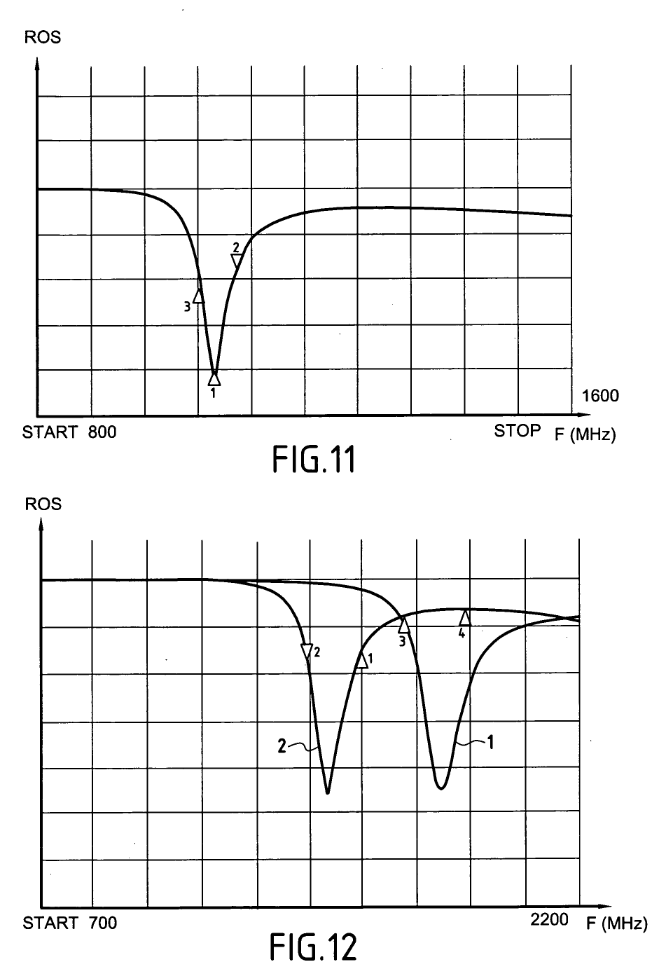

FIGS. 11 and 12 are curves showing how the antenna of FIG. 8 operates.

With reference firstly to FIGS. 1A and 1B, there follows a simplified description of an embodiment of the antenna of the invention. FIG. 1A shows a ground plane 10 and a radiating plate 12 which in this particular case constitutes the radiating element. A passive component 16 constituted in this particular case by a conductive metal plate or a conductive surface as described in greater detail below is electrically connected to the feed point of the antenna, i.e. in this embodiment to the central conductor 18 of a coaxial antenna feeder cable 20 which is itself connected to a circuit 22 for processing transmission and reception. In addition to the passive component 16, it is possible to provide additional active components such as 24 mounted between the conductive plate 16 and the ground plane. The additional active components 24 serve to modify the resonance conditions of the antenna. In this embodiment, the passive component 16 is electromagnetically coupled with the radiating plate 12, said coupling possibly being of the capacitive type or of the magnetic type, as explained below.

It will be understood that the passive element constituted by the conductive plate 16 is placed entirely facing the radiating plate and that no mechanical element connects said conductive plate to the radiating plate. It is the air that extends between these two conductive elements that allows electromagnetic coupling to take place.

FIG. 1B shows part of the FIG. 1A antenna seen from above. This figure shows that it is possible to place the passive component 16 at a point A relative to the radiating plate 12 (which is preferably rectangular in shape) such that impedance matching (e.g. at 50 ohms) is obtained directly. This disposition makes it possible to avoid using electrical components for matching impedance.

It will also be understood that there is no mechanical connection between the ground plane 10 and the radiating plate 12 and that there is no electrical connection either. Thus, for a portable radiotelephone, it is possible to fix the radiating plate 12 on the inside face of the bottom of the case of the radio-telephone while the ground plane 10 is constituted by a portion of the printed circuit of the radiotelephone.

FIG. 2 shows a first particular embodiment of the antenna of FIG. 1A when using capacitive coupling. The passive component 16 is constituted by a metal plane, e.g. of generally circular shape 30. The distance h between the conductive plane or plate 30 and the radiating plate 12 is equal to 2 millimeters (mm), whereas the distance H between the ground plane 10 and the radiating plate 12 is equal to 5 mm. In this embodiment, the dimensions of the radiating plate 12 are 41 mm×28 mm, and the dimensions of the ground plane are 51 mm×30 mm. The diameter d of the conductive plane 30 preferably lies in the range 6 mm to 8 mm. This provides capacitive coupling between the plane 30 and the radiating plate 12.

FIG. 3 shows a patch antenna with inductive coupling. In this embodiment as shown, the passive component is constituted by a conductive plate 32 connected to the ground plane 10 by a short circuit 34. Naturally, the plate 32 is connected to the central conductor 18 of the coaxial cable 20.

The radiating plate and the ground plane have the same dimensions as in the preceding example. The plane 32 is preferably rectangular in shape and presents dimensions of 8 mm by 14 mm. The distances h and H are the same as in FIG. 3.

In the inductively-coupled embodiment, the assembly constituted by the plane 32, the short circuit 34, and the corresponding portion of the ground plane acts as an exciter capable of initiating inductive coupling between itself and the radiating plate when it receives a signal from the antenna feed.

FIG. 4 shows that tests performed with the antenna of FIG. 3 produce very good results. This curve which gives the return loss (S11) or standing wave ratio (SWR) as a function of frequency shows very sharp resonance at 1.601 GHz.

With reference to FIGS. 5 to 10, there follows a description of variants of the improved embodiment of the antenna, i.e. of an antenna in accordance with the invention including matching means.

In FIG. 5, there can be seen a variant of the improved embodiment of the antenna. In this variant, there is a ground plane 10, a radiating plate 12 that forms the radiating element, a coaxial antenna feeder 20 comprising a central conductor 18 and shielding 21 electrically connected to the ground plane 10, and a passive element 16 constituted by a conductive plate facing a zone A1 of the radiating plate 12.

In this embodiment, the matching means given overall reference 40 are constituted by a variable capacitor 42 having a first plate 44 electrically connected to the ground plane 10 and its second plate 46 electrically connected to the radiating plate 12.

The conductor wire 48 connecting the plate 46 to the radiating plate 12 is connected thereto in a zone A2 which is separate from the zone A1.

By suitably choosing the capacitance of the variable capacitor 42 it is possible to adapt the passband of the antenna relative to the band which the antenna would otherwise have without the matching means, and thus to give the radiating plate 12 an antenna length that is greater than its physical length. This capacitor can be made using microstrip technology.

It can be seen that in this first embodiment, there is a mechanical connection between the ground plane and the radiating plate. Nevertheless, this connection is small and easy to make since it comprises soldering an electrical conductor to the radiating plate 12.

FIGS. 6 to 10 show four variants of the improved embodiment in which the antenna is provided with matching means.

The first embodiment is shown in FIGS. 6A and 6B. In these figures, there can be seen the ground plane 10, the radiating plate 12 parallel to the ground plane 10, and the passive element 16 facing the zone A1 of the plate 12. The passive element 16 is connected as explained above to the central conductor 18 of the coaxial feeder 20.

In this embodiment, the matching element 40 is constituted by a conductive surface or plate 50 placed entirely facing the zone A2 of the plate 12, which zone is separate from the zone A1. This plate 50 is connected by an electrical conductor 52 to the ground plane 10. The conductive plate 50 is not in contact with the radiating plate 12 either electrically or mechanically, and there is only air interposed between these two components.

With this disposition, the coupling achieved between the plate 50 and the radiating plate 12 serves to introduce the desired matching factor for modifying the width of the operating frequency band of the antenna and also for modifying the apparent length of the antenna.

In this embodiment, the distance h between the plate 50 and the radiating plate 12 is equal to 1 mm, the dimensions L and l of the round plane 10 are 110 mm by 85 mm, the dimensions L′ and l′ of the radiating plate 12 are 32 mm by 50 mm, the distances d1 and d2 between the centers of the zones A1 and A2 and the edges of the radiating plate are about 12 mm, the zones A1 and A2 are disposed substantially on the midline MM′ of the radiating plate, the diameter D of the plate 50 is 8 mm, and the diameter of the plate 16 constituting the passive component lies in the range 6 mm to 10 mm.

In the embodiment shown in FIG. 7A, the matching element 40 is still constituted by a conductive plate 50 identical to that shown in FIG. 6A, but this plate is connected to the ground plane 10 via a variable capacitor 54. Otherwise, this embodiment is identical to that of FIG. 6A. It will be understood that by giving a suitable capacitance to the variable capacitor 54 whose plates are connected electrically to the plate 50 and the ground plane 10, it is possible to adapt the width of the passband to the desired value and also to adapt the “resonant” length of the resonant plate 12.

The embodiment of FIG. 7B differs from the embodiment of FIG. 7A only by an inductor 54′ replacing the capacitor 54 mounted between the ground plane and the conductive plate 50.

FIG. 8 shows a variant embodiment in which the matching element 40 still comprises the conductive plate 50, but it is electrically connected to the central conductor 58 of a portion of coaxial cable 60. The shielding 62 of the cable is electrically connected to the ground plane 10. This portion of coaxial cable constitutes a capacitor. The length b of the coaxial cable 60 is preferably defined in such a manner as to correspond to λ/2, where λ is the main wavelength to which the antenna is tuned.

In the variant embodiment shown in FIG. 9, the matching element still comprises the conductive plate 50 for electromagnetic coupling with the radiating plate 12, but it further comprises a portion 68 of coaxial cable whose central conductor 70 is electrically connected to the plate 50 and whose shielding 72 is connected to the ground plane 10. In this embodiment, the central conductor 70 has a second end 70B opposite from its end 70A connected to the plate 50, which second end is electrically connected to the shielding 72. In this case, it is preferable for the length b2 of the coaxial cable element to be equal to λ/4, where λ is the main wavelength to which the antenna device is tuned.

In the embodiment shown in FIG. 10, the compensation element 40 is constituted by a conductive plate 50 electromagnetically coupled with the radiating plate 12. The plate 50 is connected to a Varicap diode 80. The plate 50 is also connected to the ground plane 10 via a choke 84. The diode 80 is connected by the conductor 82 to an active control circuit 86 for adjusting the width of the passband and the resonant frequency.

In all of the embodiments shown in FIGS. 6 to 10, there can be seen an antenna feed portion which is made by electromagnetic coupling between the plate 16 connected to the coaxial antenna feed cables 20 and the zone A1 of the radiating plate 12.

It will thus be understood that in all these embodiments, there is no mechanical connection between the radiating plate 12 and the elements associated with the ground plane 10, i.e. in particular the conductive surfaces 16 and 50, and it is therefore easy to fix the radiating plate 12 on the inside face of the bottom of the case of the radiotelephone and to secure the components associated with the ground plane 10 on the printed circuit of the radiotelephone.

The capacitor forming the matching component between the second passive component and the ground plane can be made using microstrip technology.

As already explained briefly, installing matching means 40 that are electromagnetically coupled to the radiating plate 12 by the conductive plate 50 and that are electrically connected to the ground plane 10 makes it possible to modify the “natural” characteristics of the antenna so as to give it characteristics that are desired, in particular concerning the width of its passband(s). More precisely, this matching is obtained by appropriately selecting the position of the passive component 40 relative to the radiating plate 12.

FIGS. 11 and 12 show curves obtained using the antenna shown in FIG. 8 with capacitance of about 1 picofarad (pF) to 10 pF and the above-described geometrical characteristics.

Installing the matching component 40 makes the following possible:

the physical length L of the radiating plate 12 can be shortened;

the passband at resonance can be increased, by reducing the Q factor; and

the resonance frequency can be controlled.

Compared with curve 4 corresponding to the embodiment of FIG. 3, curve 11 corresponding to the embodiment of FIG. 8 shows that:

the Q factory decreases, thereby increasing the width of the passband;

the first resonance is situated at a frequency of 1.07 GHz, this frequency corresponding to a half-wavelength of 140 mm in free air while the radiating element plate 12 is 50 mm long, demonstrating a shortening effect; and

the passband is of a width in excess of 50 MHz at −3 dB.

FIG. 12 shows how the resonance peak is shifted with curve 1 corresponding to a resonant frequency of 1.8 GHz and curve 2 corresponding to a resonant frequency of 1.52 GHz.

1. A patch type antenna system comprising:
groundplane-forming means; and
a radiating element disposed facing the groundplane-forming means and disposed at a predetermined distance from the plane;
the system being characterized in that it further comprises:
a passive component (16) entirely disposed facing said radiating element (12) without direct electrical contact therewith so as to provide electromagnetic coupling between said passive component and said radiating element, said passive component having no mechanical connection between itself and the radiating element so as to leave an empty gap between itself and the radiating element, said passive component being isolated from the groundplane-forming means and being electrically connectable to the antenna feed point, and in that said antenna system has no means forming a short circuit between said radiating element and said groundplane-forming means.

2. A system according to claim 1, characterized in that said coupling is of the magnetic type.

3. A system according to claim 1, characterized in that said coupling is of the capacitive type.

4. A system according to claim 2, characterized in that said passive component is constituted by a conductive plane (32) electrically connected to the antenna feed point and also connected (34) to ground.

5. A system according to claim 3, characterized in that said passive component (16) is a conductive plane connected to the antenna feed point.

6. A system according to claim 5, characterized in that said conductive plane (16) is generally in the form of a disk of dimensions that are very small compared with those of the radiating element.

7. A system according to any one of claims 1 to 5, characterized in that it further comprises active electrical elements (24) mounted between said passive electrical and the antenna feed point.

8. A system according to any one of claims 1 to 7, characterized in that said radiating element is a radiating plate (12) parallel to the groundplane-forming means (10).

9. A system according to any one of claims 1 to 8, characterized in that it further comprises matching means (40) distinct from said passive component (16) mounted between said radiating element and said groundplane-forming means.

10. A system according to claim 9, characterized in that said matching means comprise a variable capacitor (42) having one plate connected to the radiating element (12) and having its other plate connected to the groundplane-forming means.

11. A system according to claim 9, characterized in that said matching means comprise a second conductive surface (50) entirely facing a second zone of said radiating element without making electrical or mechanical contact with said radiating element, said conductive surface being electrically connected to the groundplane-forming means.

12. A system according to claim 11, characterized in that the second conductive surface (50) is connected to said groundplane-forming means via a matching component.

13. A system according to claim 12, characterized in that said matching component is constituted by a capacitor whose plates are connected respectively to said second passive component and to said groundplane-forming means.

14. A system according to claim 13, characterized in that said capacitor is constituted by a portion of coaxial cable whose central conductor is connected to the second conductive surface and whose peripheral conductor is connected to said groundplane-forming means.

15. A system according to claim 14, characterized in that said central conductor is electrically connected to the peripheral conductor.

16. A system according to claim 10 or claim 13, characterized in that said capacitor is made using microstrip technology.

17. A system according to claim 12, characterized in that said matching component is constituted by an inductor (54′) whose ends are connected respectively to said second passive component and to said groundplane-forming means.

18. A system according to claim 12, characterized in that said matching component comprises electronic components connected between said second conductive surface and said groundplane-forming means.

19. A system according to any one of claims 11 to 18, characterized in that said second conductive surface is substantially disk-shaped having dimensions that are very small relative to those of said radiating element.
